(19) United States
(12) Patent Application Publication
(10) Pub. No.: US 2022/0245160 A1
(43) Pub. Date: Aug. 4, 2022

(54) RELEVANCE PREDICTION-BASED RANKING AND PRESENTATION OF DOCUMENTS FOR INTELLIGENT SEARCHING

(71) Applicant: salesforce.com, inc., San Francisco, CA (US)

(72) Inventors: Mohamed Abdelrahman Zahran Mohamed, Redmond, WA (US); Ashish Bharadwaj Srinivasa, Mountain View, CA (US); Mario Sergio Rodriguez, Santa Clara, CA (US); Christian Posse, Belmont, CA (US)

(21) Appl. No.: 17/162,859

(22) Filed: Jan. 29, 2021

(51) Int. Cl. G06F 16/2457; G06F 16/9538; G06F 16/93

(52) U.S. Cl. CPC G06F 16/24578; G06F 16/93; G06F 16/9538

(57) ABSTRACT

In accordance with embodiments, there are provided mechanisms and methods for facilitating relevance prediction-based ranking and presentation of documents for intelligent searching in cloud computing environments in database systems according to one embodiment. In one embodiment and by way of example, a method includes receiving a query, predicting relevance of documents associated with the query based on content of the query and historical user expectations, where the relevance is predicted based on comparison of a first relevance prediction with a second relevance prediction. The method may further include ranking the documents based on the predicted relevance, where the documents are sorted based on the ranking, and communicating, in response to the query, the ranked and sorted documents to a computing device over a communication network.

### TECHNICAL FIELD

One or more implementations relate generally to database systems in cloud computing environments, and more specifically, to relevance prediction-based ranking and presentation of documents for intelligent searching in cloud computing environments.

### BACKGROUND

Conventional data management and searching techniques are severely limited in their functionalities and outputs. Further, conventional techniques employ too many tools and resources and yet they are handicapped in that they offer compromising results in terms of accuracy and scalability, which, in turn, leads to inconsistencies and errors.

“Cloud computing” services provide shared resources, software, and information to computers and other devices upon request or on demand. Cloud computing typically involves the over-the-Internet provision of dynamically scalable and often virtualized resources. Technological details can be abstracted from end-users, who no longer have need for expertise in, or control over, the technology infrastructure “in the cloud” that supports them. In cloud computing environments, software applications can be accessible over the Internet rather than installed locally on personal or in-house computer systems. Some of the applications or on-demand services provided to end-users can include the ability for a user to create, view, modify, store and share documents and other file.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The secure and efficient retrieval of accurate information and subsequent delivery of this information to the user system has been and continues to be a goal of administrators of database systems. Unfortunately, conventional database approaches are associated with various limitations.

### BRIEF DESCRIPTION OF THE DRAWINGS

In the following drawings like reference numbers are used to refer to like elements. Although the following figures depict various examples, one or more implementations are not limited to the examples depicted in the figures and that alternative implementations are within the spirit and scope of the appended claims.

FIG. 1 illustrates a system having a computing device employing a relevance prediction-based searching mechanism according to one embodiment.

FIG. 2 illustrates the relevance prediction-based searching mechanism of FIG. 1 according to one embodiment.

FIG. 3 illustrates an embodiment of a system employing a schema for intelligent and efficient searching using Permutation Invariant Groupwise Scoring Function (PI-GSF) according to one embodiment.

FIG. 4 illustrates a method for facilitating intelligent and efficient searching using PI-GSF according to one embodiment.

FIG. 5A is a block diagram illustrating an electronic device according to some example implementations.

FIG. 5B is a block diagram of a deployment environment according to some example implementations.

### DETAILED DESCRIPTION

In the following description, numerous specific details are set forth. However, embodiments of the invention may be practiced without these specific details. In other instances, well-known circuits, structures, and techniques have not been shown in detail in order not to obscure the understanding of this description.

Embodiments provide for a technique for facilitating relevance prediction-based ranking and presentation of documents for intelligent searching for database systems in cloud computing environments.

Any of the embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

It is contemplated that embodiments and their implementations are not merely limited to multi-tenant database system (“MTDBS”) and can be used in other environments, such as a client-server system, a mobile device, a personal computer (“PC”), a web services environment, etc. However, for the sake of brevity and clarity, throughout this document, embodiments are described with respect to a multi-tenant database system, such as Salesforce.com®, which is to be regarded as an example of an on-demand services environment. Other on-demand services environments include Salesforce® Exact Target Marketing Cloud™.

As used herein, a term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

A tenant includes a group of users who share a common access with specific privileges to a software instance. A multi-tenant architecture provides a tenant with a dedicated share of the software instance typically including one or more of tenant specific data, user management, tenant-specific functionality, configuration, customizations, non-functional properties, associated applications, etc. Multi-tenancy contrasts with multi-instance architectures, where separate software instances operate on behalf of different tenants.

Embodiments are described with reference to an embodiment in which techniques for facilitating management of data in an on-demand services environment are implemented in a system having an application server providing a front end for an on-demand database service capable of supporting multiple tenants, embodiments are not limited to multi-tenant databases nor deployment on application servers. Embodiments may be practiced using other database architectures, i.e., ORACLE®, DB2® by IBM and the like, without departing from the scope of the embodiments claimed.

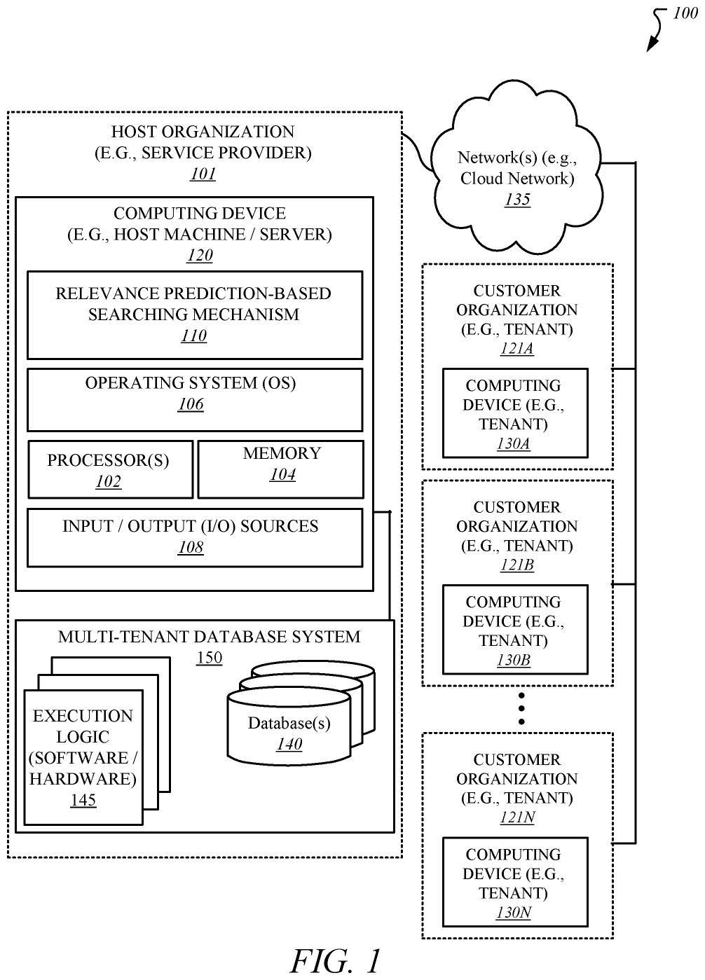

FIG. 1 illustrates a system 100 having a computing device 120 employing a relevance prediction-based searching mechanism 110 according to one embodiment. In one embodiment, relevance prediction-based searching mechanism 110 provides for a technique for facilitating relevance prediction-based ranking and presentation of documents for intelligent searching.

As illustrated, in one embodiment, computing device 120, being part of host organization 101 (e.g., service provider, such as Salesforce.com®), represents or includes a server computer acting as a host machine for relevance prediction-based searching mechanism 110 for facilitating relevance prediction-based ranking and presentation of documents for intelligent searching in a multi-tiered, multi-tenant, on-demand services environment.

It is to be noted that terms like “queue message”, “job”, “query”, “request” or simply “message” may be referenced interchangeably and similarly, terms like “job types”, “message types”, “query type”, and “request type” may be referenced interchangeably throughout this document. It is to be further noted that messages may be associated with one or more message types, which may relate to or be associated with one or more customer organizations, such as customer organizations 121A, 121B, 121N, where, as aforementioned, throughout this document, “customer organizations” may be referred to as “tenants”, “customers”, or simply “organizations”. An organization, for example, may include or refer to (without limitation) a business (e.g., small business, big business, etc.), a company, a corporation, a non-profit entity, an institution (e.g., educational institution), an agency (e.g., government agency), etc.), etc., serving as a customer or client of host organization 101 (also referred to as “service provider” or simply “host”), such as Salesforce.com®, serving as a host of relevance prediction-based searching mechanism 110.

Similarly, the term “user” may refer to a system user, such as (without limitation) a software/application developer, a system administrator, a database administrator, an information technology professional, a program manager, product manager, etc. The term “user” may further refer to an end-user, such as (without limitations) one or more of tenants or customer organizations 121A-N and/or their representatives (e.g., individuals or groups working on behalf of one or more of customer organizations 121A-N), such as a salesperson, a sales manager, a product manager, an accountant, a director, an owner, a president, a system administrator, a computer programmer, an information technology (“IT”) representative, etc.

Computing device 120 may include (without limitations) server computers (e.g., cloud server computers, etc.), desktop computers, cluster-based computers, set-top boxes (e.g., Internet-based cable television set-top boxes, etc.), etc. Computing device 120 includes an operating system (“OS”) 106 serving as an interface between one or more hardware/physical resources of computing device 120 and one or more client devices 130A, 130B, 130N, etc. Computing device 120 further includes processor(s) 102, memory 104, input/output (“I/O”) sources 108, such as touchscreens, touch panels, touch pads, virtual or regular keyboards, virtual or regular mice, etc. Client devices 130A-130N may be regarded as external computing devices.

In one embodiment, host organization 101 may employ a production environment that is communicably interfaced with client devices 130A-N through host organization 101. Client devices 130A-N may include (without limitation) customer organization-based server computers, desktop computers, laptop computers, mobile computing devices, such as smartphones, tablet computers, personal digital assistants, e-readers, media Internet devices, smart televisions, television platforms, wearable devices (e.g., glasses, watches, bracelets, smartcards, jewelry, clothing items, etc.), media players, global positioning system -based navigation systems, cable setup boxes, etc. In some embodiments, client devices 130A-include artificially intelligent devices, such as autonomous machines including (without limitations) one or more of autonomous vehicles, drones, robots, smart household appliances, smart equipment, etc.

In one embodiment, the illustrated multi-tenant database system 150 includes database(s) 140 to store (without limitation) information, relational tables, datasets, and underlying database records having tenant and user data therein on behalf of customer organizations 121A-N (e.g., tenants of multi-tenant database system 150 or their affiliated users). In alternative embodiments, a client-server computing architecture may be utilized in place of multi-tenant database system 150, or alternatively, a computing grid, or a pool of work servers, or some combination of hosted computing architectures may be utilized to carry out the computational workload and processing that is expected of host organization 101.

The illustrated multi-tenant database system 150 is shown to include one or more of underlying hardware, software, and logic elements 145 that implement, for example, database functionality and a code execution environment within host organization 101. In accordance with one embodiment, multi-tenant database system 150 further implements databases 140 to service database queries and other data interactions with the databases 140. In one embodiment, hardware, software, and logic elements 145 of multi-tenant database system 140 and its other elements, such as a distributed file store, a query interface, etc., may be separate and distinct from customer organizations (121A-121N) which utilize the services provided by host organization 101 by communicably interfacing with host organization 101 via network(s) 135 (e.g., cloud network, the Internet, etc.). In such a way, host organization 101 may implement on-demand services, on-demand database services, cloud computing services, etc., to subscribing customer organizations 121A-121N.

In some embodiments, host organization 101 receives input and other requests from a plurality of customer organizations 121A-N over one or more networks 135; for example, incoming search queries, database queries, application programming interface (“API”) requests, interactions with displayed graphical user interfaces and displays at client devices 130A-N, or other inputs may be received from customer organizations 121A-N to be processed against multi-tenant database system 150 as queries via a query interface and stored at a distributed file store, pursuant to which results are then returned to an originator or requestor, such as a user of client devices 130A-N at any of customer organizations 121A-N.

As aforementioned, in one embodiment, each customer organization 121A-N is an entity selected from a group consisting of a separate and distinct remote organization, an organizational group within host organization 101, a business partner of host organization 101, a customer organization 121A-N that subscribes to cloud computing services provided by host organization 101, etc.

In one embodiment, requests are received at, or submitted to, a web server within host organization 101. Host organization 101 may receive a variety of requests for processing by host organization 101 and its multi-tenant database system 150. For example, incoming requests received at the web server may specify which services from host organization 101 are to be provided, such as query requests, search request, status requests, database transactions, graphical user interface requests and interactions, processing requests to retrieve, update, or store data on behalf of one of customer organizations 121A-N, code execution requests, and so forth. Further, the web-server at host organization 101 may be responsible for receiving requests from various customer organizations 121A-N via network(s) 135 on behalf of the query interface and for providing a web-based interface or other graphical displays to one or more end-user client devices 130A-N or machines originating such data requests.

Further, host organization 101 may implement a request interface via the web server or as a stand-alone interface to receive requests packets or other requests from the client devices 130A-N. The request interface may further support the return of response packets or other replies and responses in an outgoing direction from host organization 101 to one or more client devices 130A-N.

It is to be noted that any references to software codes, data and/or metadata (e.g., Customer Relationship Management (“CRM”) data and/or metadata, etc.), tables (e.g., custom object table, unified index tables, description tables, etc.), computing devices (e.g., server computers, desktop computers, mobile computers, such as tablet computers, smartphones, etc.), software development languages, applications, and/or development tools or kits (e.g., Force.com®, Force.com Apex™ code, JavaScript™, jQuery™, Developerforce™, Visualforce™, Service Cloud Console Integration Toolkit (“Integration Toolkit” or “Toolkit”), Platform on a Service™ (“PaaS”), Chatter® Groups, Sprint Planner®, MS Project®, etc.), domains (e.g., Google®, Facebook®, LinkedIn®, Skype®, etc.), etc., discussed in this document are merely used as examples for brevity, clarity, and ease of understanding and that embodiments are not limited to any particular number or type of data, metadata, tables, computing devices, techniques, programming languages, software applications, software development tools/kits, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, “multi-tenant on-demand data system”, and the like, may be used interchangeably throughout this document. It is to be further noted that terms like “code”, “software code”, “application”, “software application”, “program”, “software program”, “package”, “software code”, “code”, and “software package” may be used interchangeably throughout this document. Moreover, terms like “job”, “input”, “request”, and “message” may be used interchangeably throughout this document.

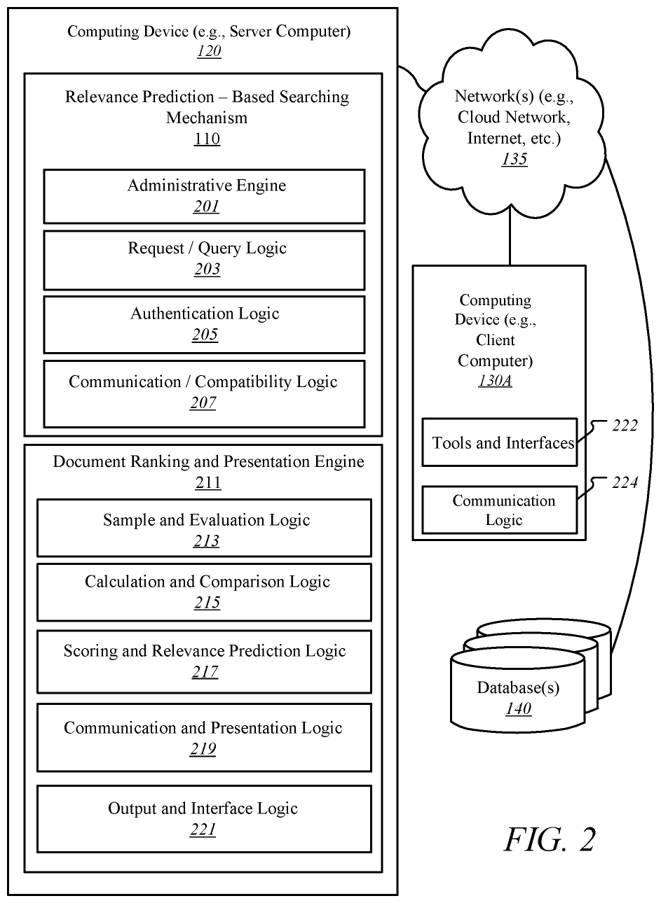

FIG. 2 illustrates relevance prediction-based searching mechanism 110 of FIG. 1 according to one embodiment. In one embodiment, relevance prediction-based searching mechanism 110 provides for facilitating control and management of financial transactions so that any potential duplications of such transactions are detected, analyzed, and avoided when communicating with multiple transaction entities, such as transaction gateways, transaction gateway adapters, etc. Further, such transactions may be associated with users and/or tenants (e.g., organizations) and include financial transactions, in multi-tenant database systems, where relevance prediction-based searching mechanism 110 includes any number and type of components, such as administration engine 201 having (without limitation): request/query logic 203; authentication logic 205; and communication/compatibility logic 207. Similarly, relevance prediction-based searching mechanism 110 may further include ranking and presentation engine 211 including (without limitations): sample and evaluation logic 213; calculation and comparison logic 215; scoring and relevance prediction logic 217; communication and response logic 219; and interface logic 221.

In one embodiment, computing device 120 may serve as a service provider core (e.g., Salesforce.com® core) for hosting and maintaining relevance prediction-based searching mechanism 110 and be in communication with one or more database(s) 140, client computer 130A, over one or more network(s) 135, and any number and type of dedicated nodes. In one embodiment, one or more database(s) 140 may be used to host, hold, or store data including interface details, API documentation, tool information, menus, objects, tables, code samples, HTTP client data, messages, queries, tenant and organization data, etc.

As will be further described in this document, computing device 120 serves as a data management server computer (supported by a service provider, such as Salesforce.com®) for facilitating intelligent searching and sorting and ranking and communicating of resulting documents to one or more client computing devices, client computing device 130A over one or more network(s) 135 (e.g., cloud network, Internet, etc.). Server computer 120 and/or client computer 130A are further shown in communication with database(s) 140 over network(s) 135. Further, client devices, such as client device 130A, allow for users to place queries, access information, receive query results, etc., using one or more user interfaces, as facilitated by tools and interfaces 222, and communication logic 224.

Throughout this document, terms like “framework”, “mechanism”, “engine”, “logic”, “component”, “module”, “tool”, “builder”, “circuit”, and “circuitry”, may be referenced interchangeably and include, by way of example, software, hardware, firmware, or any combination thereof. Further, any use of a particular brand, word, or term, such as “query”, “data”, “images”, “videos”, “product”, “description”, “detail”, “sensitive data”, “personal data”, “user data”, “relevance scores”, “relevance prediction”, “ranking losses”, “ranking gains”, “calculating”, “comparing”, “ranking”, “sorting”, “communicating”, “presenting”, “application programming interface”, “API request”, “user interface”, “sales cloud”, “code”, “metadata”, “business software”, “application”, “database servers”, “metadata mapping”, “database”, etc., should not be read to limit embodiments to software or devices that carry that label in products or in literature external to this document.

As aforementioned, with respect to FIG. 1, any number and type of requests and/or queries may be received at or submitted to request/query logic 203 for processing. For example, incoming requests may specify which services from computing device 120 are to be provided, such as query requests, search request, status requests, database transactions, graphical user interface requests and interactions, processing requests to retrieve, update, or store data, etc., on behalf of client device 130A, code execution requests, and so forth.

In one embodiment, computing device 120 may implement request/query logic 203 to serve as a request/query interface via a web server or as a stand-alone interface to receive requests packets or other requests from the client device 130A. The request interface may further support the return of response packets or other replies and responses in an outgoing direction from computing device 120 to one or more client device 130A.

Similarly, request/query logic 203 may serve as a query interface to provide additional functionalities to pass queries from, for example, a web service into the multi-tenant database system for execution against database(s) 140 and retrieval of customer data and stored records without the involvement of the multi-tenant database system or for processing search queries via the multi-tenant database system, as well as for the retrieval and processing of data maintained by other available data stores of the host organization's production environment. Further, authentication logic 205 may operate on behalf of the host organization, via computing device 120, to verify, authenticate, and authorize, user credentials associated with users attempting to gain access to the host organization via one or more client device 130A.

In one embodiment, computing device 120 may include a server computer which may be further in communication with one or more databases or storage repositories, such as database(s) 140, which may be located locally or remotely over one or more networks, such as network(s) 135 (e.g., cloud network, Internet, proximity network, intranet, Internet of Things (“IoT”), Cloud of Things (“CoT”), etc.). Computing device 120 is further shown to be in communication with any number and type of other computing devices, such as client device 130A, over one or more communication mediums, such as network(s) 140.

It is contemplated that ranking and/or sorting of results in response to search queries is essential to any search technique. With billions of searches and data files, intelligent and organized searches are desired to not only prevent any potential clogging of a system, but also to offer results that are customized for users in terms of relevance, quantity, and speed. One manner of highlighting relevance is ranking.

Conventional search and sorting/ranking techniques are severely limited in their functionalities and outputs. Conventional techniques are limited to sampling full permutations, which is computationally infeasible and thus such conventional techniques are limited to considering random samples, which handicaps such techniques in terms of scalability and compromises accuracy of their search results.

Ranking is regarded as a core component for search techniques. Given a query and its associated documents, a ranking engine may score these documents by their relevance to a given query and sort these documents based on calculated relevance scores and present these sorted documents to users via client computers. One model for scoring documents is referred to as Groupwise Scoring Function (GSF), where GSF handles a query and a set of associated documents of size k by scoring m documents out of k jointly. However, GSF has several shortcomings and limitations.

For example, (1) if the number of documents associated with a query is k, where k is larger than m, then GSF may score all possible permutations of k documents among m groups, which is computationally infeasible in most cases. Further, GSF may just sample the full permutation, which can leave the GSF ranking model vulnerable to variance resulting from sampling. For example, if there is a query with three documents (such as d1, d2, d3) and a group size (such as m=2), then the full permutations is expected to be as follows: {(d1,d2), (d1,d3), (d2,d3), (d2,d1), (d3,d1), (d3,d2)}. Since such full permutations are computationally infeasible, GSF may be limited in considering a random sample, such as {(d1,d2), (d2,d3)}, which assigns this ranking to the documents: d1, d2, d3. Since sampling is random, another possible sample is {(d3,d2), (d1,d3)}, which may assign a different ranking to the documents: d1, d3, d2, making GSF sensitive to sampling.

Further, (2) another issue with the conventional GSF technique is lack of scalability. For example, increasing m allows for more documents to be scored jointly which, in turn, can improve ranking accuracy; however, increasing m may dramatically increase the size of the full permutation which, in turn, may increase the samples needed in order to properly train a GSF model.

Conventional techniques, such as Groupwise Scoring Function (GSF), are severely limited in their functionalities and outputs. Conventional techniques sample full permutations which allows for inconsistent results. Further, since sampling full permutations is computationally infeasible, such conventional techniques are limited to considering random samples, further compromising the accuracy of results. Conventional techniques are further handicapped in terms of scalability.

Embodiments provide for a novel technique for receiving and analyzing queries and accessing associated documents for sorting/ranking of documents based on predictions of their relevance to a user such that the documents are sorted, ranked, and then communicated to users. Embodiments provide for evaluation of query contents along with historical user expectations to obtain known relevance and calculate likely relevance, which are then compared for determining and assigning relevance scores to any relevant documents. These relevance scores are used for predicting relevance and sorting and ranking of documents for better results in response to queries.

In one embodiment, historical user expectations are based on previous user experiences relating to documents associated with certain queries. For example, in viewing a set of documents in response to a query, whether a user reviewing the set of documents, such as through tool and interfaces 222 at client device 130, found or regarded one or more documents of the set of documents more relevant over other documents. For example, documents A, B, and C are returned to the user in response to a query, where the user may find document A to have more relevant information than documents B and C and this relevance may be determined through one or more factors, such as how often the user clicks on or opens document A as compared to documents B and C, any information from document has been highlighted or copied/cut and pasted, saving of document A and/or deleting or disregarding of documents B and/or C, and/or the like.

How a document, such as document A from the above example, is treated may be determined using tools and interfaces 222 at client device 130A, where this treatment data may then the communicated over to document ranking and presentation engine 211 for sample and evaluation logic 213 to sample and analyze the treatment data to then allow the scoring and relevance prediction logic 217 to pre-assign relevance to documents A, B, and C and save this relevance assignment data at database(s) 140. This pre-assigned relevance represents what is expected of the user with respect to certain documents and queries and thus regarded as historical user expectations. Further, this pre-assigned relevance is stored, such as at database(s) 140, so it may be accessed for comparison with any predicated relevance (as described later in this document).

Embodiments provide a novel technique for analyzing queries and associated documents for ranking the documents based on predictions of their relevance to a user such that the documents are communicated ranked and sorted to the user. Embodiments further provide for one or more of (1) calculating relevance scores and predicting relevance, (2) training of models/engines to encourage variance in predictions, (3) detecting and evaluating ranking losses and gains over time to strengthen relevance scores and, in turn, relevance predictions, and (4) regularizing current techniques by controlling sample sensitivities.

Embodiments offer a novel Permutation Invariant GSF (PI-GSF) as facilitated by relevance prediction-based searching mechanism 110 including ranking and presentation engine 211. In one embodiment, PI-GSF may be viewed as a form of regularization to GSF that allows for improving and controlling its sampling sensitivity. In one embodiment, this is achieved by training a model in a manner that encourages the variance in predictions under different sampling masks to be as small as possible, such as by modifying a training loss function to be composed of two parts: (1) ranking losses and (2) difference between the model's predictions using two independently and identically distributed (IID) sampling masks over the full permutation. Further, a controlling hyper-parameter (gamma) is added to PI-GSF to allow for controlling how conservative the model is toward changing its scores according to a sampling mask that is used.

For example, as facilitated by relevance prediction-based searching mechanism 110 and as further facilitated by ranking and presentation engine 211: (1) let s_1 and s_2 be two IID sampling masks over a full permutation; (2) let f(.) be the prediction function of the model, and let f(Q, D, s_1) be the model's prediction for query-documents (Q, D) under the sampling mask s_1; (3) let f(Q, D, s_2) be the model's predictions for query-documents (Q, D) under the sampling mask's s_2; (4) let Y be the correct ranking of the documents D. (5) let L be the ranking loss between the model's ranking prediction f(.) and the correct prediction (Y).

By using the two different sampling masks (s_1, s_2) two different predictions are obtained, where the overall loss accounts for the ranking loss of both predictions and the difference in prediction due to using two different sampling masks. The final loss function is:

$$ℒ = \frac{1}{2} [ L ( f ( Q , D , {s}_{1} ) , Y ) + L ( F ( Q , D , {s}_{2} ) , Y ) ] + \frac{γ}{\vert D \vert} H$$

Where, H is the regularization term that penalizes different predictions from two different sampling masks, and where gamma is a hyper-parameter controlling the impact of the regularization on the total loss. |D| is the number of documents. Further, the term H may be any function that penalizes the difference in predictions, such as H may be the L2 norm of the difference between the predictions using the two sampling masks as follows:

$$H = {𝔼}_{{s}_{1} , {s}_{2}} [ {‖ f ( Q , D , {s}_{1} ) - f ( Q , D , {s}_{2} ) ‖}_{2}^{2} ] = 2 {\sum }_{i = 1}^{k} {var}_{{s}_{1}} [ {f}_{i} ( Q , D ) ]$$

Referring back to ranking and presentation engine 211 of relevance prediction-based searching mechanism 110, a query is received from a user having access to client device 130A. For example, the user may place a query for documents using one or more search engines offered through tools and interfaces 222 and communicated to server device 120 via communication logic 224 and communication/compatibility logic 207 and received by relevance prediction-based searching mechanism 110 via request/query logic 203.

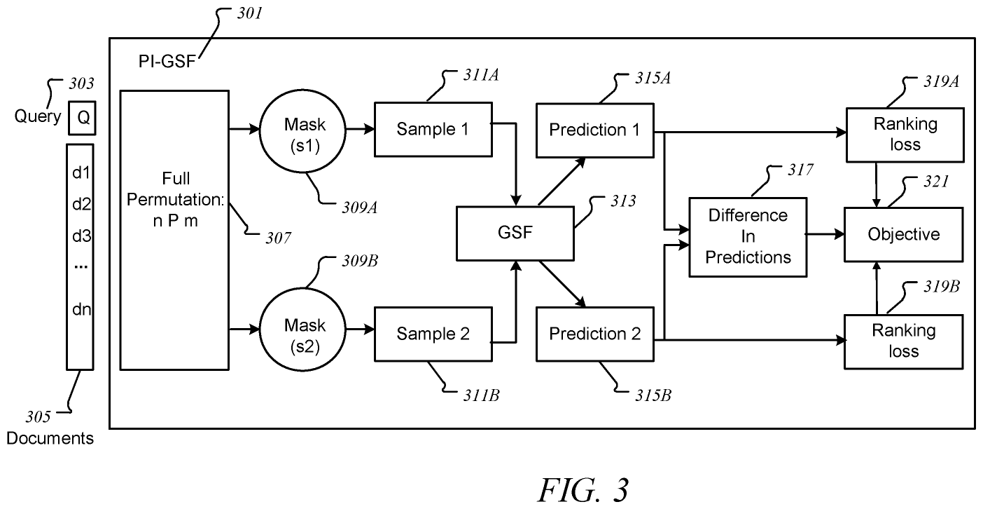

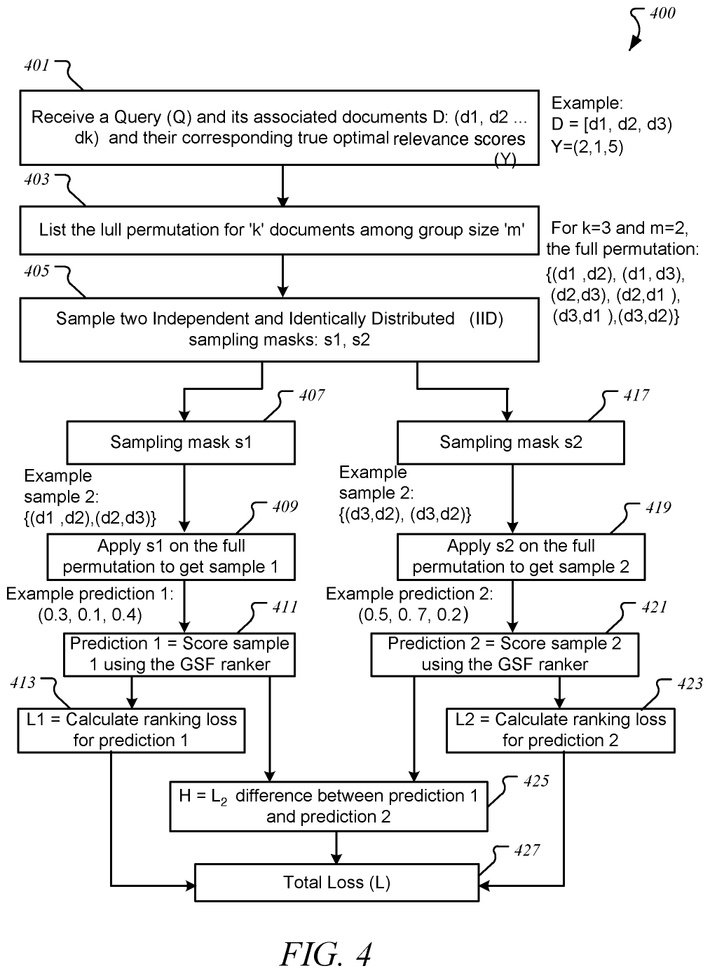

As will be further illustrated and described with reference to FIGS. 3-4, in one embodiment, sample and evaluation logic 213 of document ranking and presentation engine 211 is triggered during training the PI-GSF model. After the PI-GSF model is trained, predictions can be made similar to GSF.

During training, for each query and its associated list of k documents. PI-GSF (with group size m) samples the full permutations of k among m twice. These two samples are used to predict scores for each of the k documents, the prediction loss of each sample is calculated, in addition to the difference in predictions between the two samples, all of which contribute to the total loss function of the objective.

For example, calculation and comparison logic 215 may trigger PI-GSF to compare the two original samples to offer two corresponding predictions, such as the first prediction of relevance and the second prediction of relevance. These predictions, obtained through the PI-GSF processing, are then compared with each other to determine any differences between the two predictions as facilitated by calculation and comparison logic 215.

For example, any data obtained from comparing the first prediction with the second prediction is forwarded on by calculation and comparison logic 215 to scoring and relevance prediction logic 217. This data is then evaluated to see if there had been any loss or gain of relevance with respect to the first prediction as facilitated by scoring and relevance prediction logic 217.

In one embodiment, scoring and relevance prediction logic 217 assigns scores to the documents associated with the query so that the true or current relevance of each document is highlighted. This is because this scoring may then be used to rank these documents in the order of relevance, as facilitated by scoring and relevance prediction logic 217, where this ranking of the documents is then used to sort the documents (such as in descending order) based on their assigned rankings that are further based on their relevance scores and these sorted documents are then forwarded on from scoring and relevance prediction logic 217 to communication and presentation logic 219.

In one embodiment, relevance may reveal how important or pertinent the document is to the user placing the query based on the contents or the subject matter of the query, historical expectations of the user, and any current or ongoing development. For example, if a first document has been updated or replaced with a second document, then even if the first document has been regarded as relevant by the user in the past.

Upon receiving the sorted documents, communication and presentation logic 219 may then prepare the documents for presentation in a sorted format, while fixing or removing any errors or anomalies, etc., and communicate an output having the final version of the sorted documents to client device 130A over network(s) 135 (e.g., cloud network) for display at client device 130A using a display screen and as facilitated by tools and interfaces 222 and communication logic 224.

Embodiments allow for the user to access and view any number of documents associated with the query in a sorted manner, where the documents are efficiently sorted in accordance with their ranking which is further in accordance with their relevance scores. In one embodiment, using the novel PI-GSF, in one embodiment, an intelligent and efficient manner of searching for query and outputting documents relevant to a query is offered. For example, following is a table indicating the varying results obtained from applying the conventional GSF technique and the novel PI-GSF technique to searches, where the PI-GSF results are clearly superior to the conventional GSF outputs measured by Normalized Discounted Cumulative Gain (NDCG) levels using a public dataset. As follows, higher numbers are better in NDCG, and best scores are bold and underlined.

| Model | NDCG@1 | NDCG@2 | NDCG@3 | NDCG@4 | NDCG@5 | NDCG@6 | NDCG@7 | NDCG@8 | NDCG@9 | NDCG@10 |
|---|---|---|---|---|---|---|---|---|---|---|
| Standard GSF | 0.65905 | 0.662 | 0.67316 | 0.68546 | 0.6975 | 0.70887 | 0.71937 | 0.72861 | 0.737 | 0.74377 |
| sampling iter 2 | 0.65538 | 0.65967 | 0.67053 | 0.68373 | 0.69623 | 0.70747 | 0.71812 | 0.7272 | 0.73569 | 0.74304 |
| sampling iter 3 | 0.6618 | 0.66259 | 0.67206 | 0.68508 | 0.69745 | 0.7087 | 0.71929 | 0.72868 | 0.7374 | 0.74455 |
| Mean | 0.65875 | 0.66142 | 0.67192 | 0.68476 | 0.69706 | 0.70835 | 0.71893 | 0.72816 | 0.7367 | 0.74379 |
| PI-GSF | 0.67436 | 0.67902 | 0.69053 | 0.70317 | 0.7156 | 0.7268 | 0.73743 | 0.74642 | 0.75524 | 0.76237 |
| sampling iter 2 | 0.6727 | 0.67761 | 0.68912 | 0.70239 | 0.71412 | 0.72519 | 0.73559 | 0.74565 | 0.75413 | 0.76165 |
| sampling iter 3 | 0.67614 | 0.68085 | 0.69198 | 0.70442 | 0.71624 | 0.72778 | 0.73752 | 0.74732 | 0.7561 | 0.76329 |
| Mean | 0.6744 | 0.67916 | 0.69055 | 0.70333 | 0.71532 | 0.72659 | 0.73685 | 0.74646 | 0.75515 | 0.76244 |

As mentioned previously, it is contemplated that queries may include any number and type of requests seeking responses for processing jobs, running reports, seeking data, etc. These queries are typically placed by users on behalf of tenants, using client device 130A. It is contemplated that a tenant may include an organization of any size or type, such as a business, a company, a corporation, a government agency, a philanthropic or non-profit entity, an educational institution, etc., having single or multiple departments (e.g., accounting, marketing, legal, etc.), single or multiple layers of authority (e.g., C-level positions, directors, managers, receptionists, etc.), single or multiple types of businesses or sub-organizations (e.g., sodas, snacks, restaurants, sponsorships, charitable foundation, services, skills, time etc.) and/or the like

Communication/compatibility logic 207 may facilitate the ability to dynamically communicate and stay configured with any number and type of software/application developing tools, models, data processing servers, database platforms and architectures, programming languages and their corresponding platforms, etc., while ensuring compatibility with changing technologies, parameters, protocols, standards, etc.

It is contemplated that any number and type of components may be added to and/or removed from relevance prediction-based searching mechanism 110 to facilitate various embodiments including adding, removing, and/or enhancing certain features. It is contemplated that embodiments are not limited to any technology, topology, system, architecture, and/or standard and are dynamic enough to adopt and adapt to any future changes.

FIG. 3 illustrates an embodiment of a system 300 employing a schema for intelligent and efficient searching using PI-GSF according to one embodiment. It is to be noted that for brevity, clarity, and ease of understanding, many of the components and processes described with respect to FIGS. 1-2 may not be repeated or discussed hereafter.

As illustrated, system 300 employs PI-GSF 301 for intelligent searching of documents 305 in response to query 303 so that an efficient output based on objective 321 may be produced, where the output offers a unique sorting of documents 305 based on their current and/or future relevance to query 303 and one or more users placing query 303 at one or more client computing devices.

As further discussed with reference to FIG. 2, once query 303 is received from client device over a communication network, such as a cloud network, it is then processed based on its contents and associated documents 305 (e.g., d1, d2, d3 . . . dn). In one embodiment, as illustrated, PI-GSF 301 allows for full permutation 307 for better control of sampling sensitivities through training of one or more machine/deep learning models in a way that encourages variances in predictions 315A, 315B under different sampling masks 309A, 309B to be as small as possible, such as by modifying a training loss function to be composed of two parts: (1) ranking losses 319A, 319B and (2) any difference between the model's predictions 317 using two independently and identically distributed (IID) sampling masks 309A, 309B over the full permutation 307. Further, a controlling hyper-parameter (gamma) is added to PI-GSF 301 to allow for controlling how conservative the model is toward changing its scores according to a sampling mask 309A, 309B that is used.

Now, as facilitated by relevance prediction-based searching mechanism 110 and as further facilitated by ranking and presentation engine 211 of FIG. 2, for example: (1) let s_1 309A and s_2 309B be two IID sampling masks over full permutation 307; (2) let f(Q, D, s_1) be the model's prediction, prediction 1 315A corresponding to sample 1 311A, for query-documents (Q, D) under the sampling mask s_1 307A; (3) let f(Q, D, s_2) let be the model's prediction, such as prediction 2 315B corresponding to sample 2 311B, for query-documents (Q, D) under the sampling mask's s_2 309B; (4) now, let Y be the correct ranking; then (5) let L be ranking loss 319A, 319B between the model's ranking prediction (f(.)) and the correct prediction (Y) as determined from prediction 1 315A and prediction 2 315B and as facilitated by PI-GSF-based GSF 313. This difference between prediction 1 315, 2 315B is computed and recorded as difference in predictions 317 and any ranking losses 319A, 319B are also recorded, while based and on difference 317 and ranking loss 319, 319B, objective 321 is achieved, reflecting the correct prediction based on accurate relevance of documents 315 to query 303 and the user that placed query 303.

By using the two different sampling masks 309A, 309B, two different predictions 315A, 315B are obtained, where the overall loss accounts for the ranking loss 319A, 319B of both predictions 315A, 315B, respectively, and difference in predictions 317 due to using two different sampling masks 309A, 309B. In one embodiment, using the above-referenced factors, the final loss function may be recited as follows:

$$ℒ = \frac{1}{2} [ L ( f ( Q , D , {s}_{1} ) , Y ) + L ( F ( Q , D , {s}_{2} ) , Y ) ] + \frac{γ}{\vert D \vert} H$$

Where, H is the regularization term that penalizes different predictions 315A, 315B from two different sampling masks 309A, 309B, and where gamma is a hyper-parameter controlling the impact of the regularization on the total loss. Further, the term H may be any function that penalizes difference in predictions 317, such as H may be the L2 norm of the difference between predictions 317 using the two sampling masks 309A, 309B as follows:

$$H = {𝔼}_{{s}_{1} , {s}_{2}} [ {‖ f ( Q , D , {s}_{1} ) - f ( Q , D , {s}_{2} ) ‖}_{2}^{2} ] = 2 {\sum }_{i = 1}^{k} {var}_{{s}_{1}} [ {f}_{i} ( Q , D ) ]$$

As previously discussed with reference to FIG. 2, any outcome is based on objective 321 considering ranking loss 319A, 319B and any other factors and includes an efficiently sorted list of documents 305 that is communicated to the client device over a communication network for the user to access and view.

It is contemplated that system 300 is illustrated as an example for brevity, clarity, and ease of understanding and that embodiments are not limited as such. For example, embodiments are not limited to any number or type of masks, samples, predictions, differences in prediction, or even ranking losses or gains, or any number or type of queries or documents, etc. Similarly, nor are embodiments limited to the arrangements or placements of any of the components and/or processes illustrated in system 300.

FIG. 4 illustrates a method 400 for facilitating intelligent and efficient searching using PI-GSF according to one embodiment. Method 400 may be performed by processing logic that may comprise hardware (e.g., circuitry, dedicated logic, programmable logic, etc.), software (such as instructions run on a processing device), or a combination thereof In one embodiment, method 400 may be performed or facilitated by one or more components of relevance prediction-based searching mechanism 110 of FIG. 1. The processes of method 400 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-3 may not be repeated or discussed hereafter.

As illustrated, method 400 begins at block 401 with receiving of a query (Q) and its associated documents (D) and their corresponding true optimal relevance scores (Y). For example, D may include d1, d2, d3, corresponding to Y equaling 2, 1, 5, etc. At block 403, a list of full permutations for ‘k’ documents among group size ‘m’ is prepared. For example, if k=3, m=2, then the full permutation may equal: {(d1, d2), (d1, d3), (d2, d3), (d2, d1), (d3, d1), (d3, d2)}.

In one embodiment, at block 405, two IID sampling masks (e.g., s1, s2) are chosen by sampling the full permutation twice obtaining s1 and s2. s1 is then applied on the full permutation to obtain sample 1, while at block 419, s2 is applied on the full permutation to obtain sample 2. For example, sample 1 may equal {(d1, d2), (d2, d3)}, while sample 2 may equal {(d3, d2), (d3, d1)}. In one embodiment, this is followed by generation of prediction 1 equaling a score sample 1 using the PI-GSF ranker at block 411 and similarly, prediction 2 is generated equaling a score sample 2 using the GSF ranker at block 421. For example, prediction 1 may equal 0.3, 0.1, 0.4, (corresponding to d1, d2, d3) while prediction 2 may equal 0.5, 0.7, 0.2 (corresponding to d1, d2, d3).

Using the two predictions, in one embodiment, at blocks 413 and 423, L1 referring to ranking loss 1 is calculated for prediction 1 and L2 referring to ranking loss 2 is calculated for prediction 2, respectively. At block 425, in one embodiment, the two predictions are compared to obtain the difference, H, between the two predictions, resulting in total loss (L) at block 427.

Example Electronic Devices and Environments. One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all the instructions in that program.

An electronic device (also referred to as a device, computing device, computer, computer server, cloud computing server, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

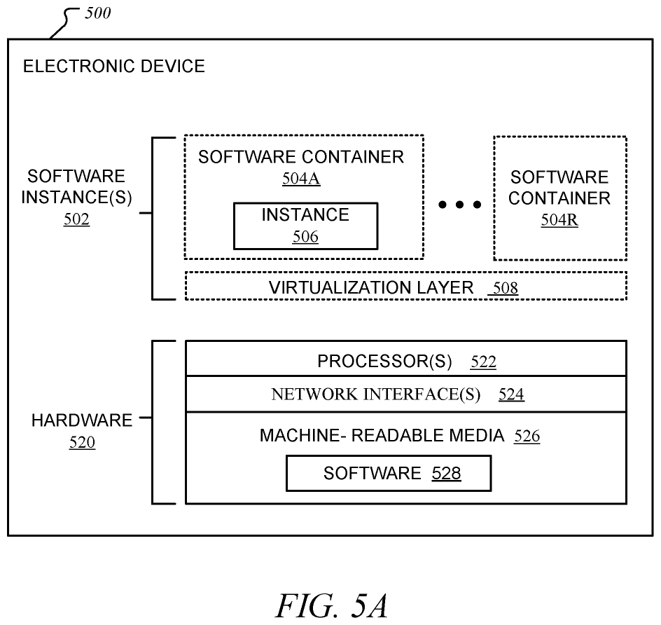

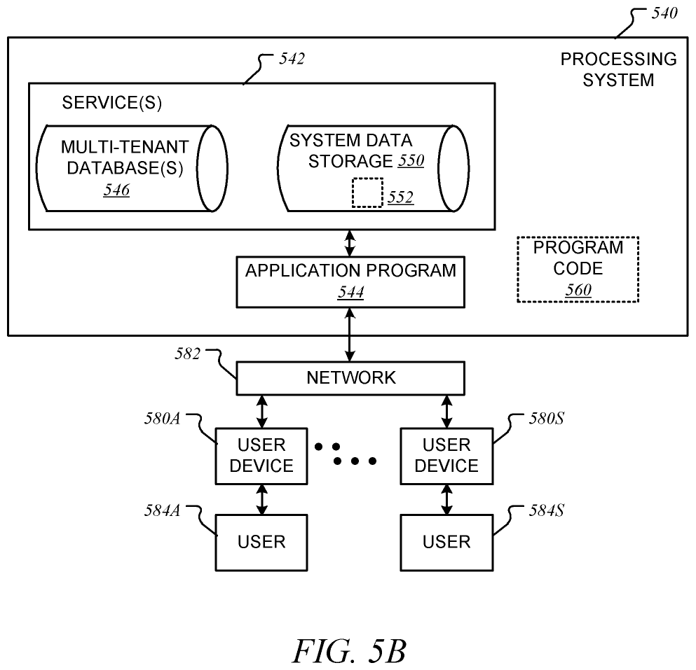

FIG. 5A is a block diagram illustrating an electronic device 500 according to some example implementations. FIG. 5A includes hardware 520 comprising a set of one or more processor(s) 522, a set of one or more network interfaces 524 (wireless and/or wired), and machine-readable media 526 having stored therein software 528 (which includes instructions executable by the set of one or more processor(s) 522). The machine-readable media 526 may include non-transitory and/or transitory machine-readable media. Each of the previously described clients and relevance prediction-based searching mechanism 110 may be implemented in one or more electronic devices 500. In one implementation: 1) each of the clients is implemented in a separate one of the electronic devices 500 (e.g., in end user devices where the software 528 represents the software to implement clients to interface directly and/or indirectly with relevance prediction-based searching mechanism 110 (e.g., software 528 represents a web browser, a native client, a portal, a command-line interface, and/or an application programming interface (API) based upon protocols such as Simple Object Access Protocol (SOAP), Representational State Transfer (REST), etc.)); 2) relevance prediction-based searching mechanism 110 is implemented in a separate set of one or more of the electronic devices 500 (e.g., a set of one or more server devices where the software 528 represents the software to implement relevance prediction-based searching mechanism 110); and 3) in operation, the electronic devices implementing the clients and relevance prediction-based searching mechanism 110 would be communicatively coupled (e.g., by a network) and would establish between them (or through one or more other layers and/or or other services) connections for submitting UI interactions log data to relevance prediction-based searching mechanism 110 and returning alerts and reports 122, and time series DB 124 to the clients. Other configurations of electronic devices may be used in other implementations (e.g., an implementation in which the client and relevance prediction-based searching mechanism 110 are implemented on a single one of electronic device 500).

During operation, an instance of the software 528 (illustrated as instance 506 and referred to as a software instance; and in the more specific case of an application, as an application instance) is executed. In electronic devices that use compute virtualization, the set of one or more processor(s) 522 typically execute software to instantiate a virtualization layer 508 and one or more software container(s) 504A-504R (e.g., with operating system-level virtualization, the virtualization layer 508 may represent a container engine (such as Docker Engine by Docker, Inc. or rkt in Container Linux by Red Hat, Inc.) running on top of (or integrated into) an operating system, and it allows for the creation of multiple software containers 504A-504R (representing separate user space instances and also called virtualization engines, virtual private servers, or jails) that may each be used to execute a set of one or more applications; with full virtualization, the virtualization layer 508 represents a hypervisor (sometimes referred to as a virtual machine monitor (VMM)) or a hypervisor executing on top of a host operating system, and the software containers 504A-504R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 528 is executed within the software container 504A on the virtualization layer 508. In electronic devices where compute virtualization is not used, the instance 506 on top of a host operating system is executed on the “bare metal” electronic device 500. The instantiation of the instance 506, as well as the virtualization layer 508 and software containers 504A-504R if implemented, are collectively referred to as software instance(s) 502.

Alternative implementations of an electronic device may have numerous variations from that described above. For example, customized hardware and/or accelerators might also be used in an electronic device.

Example Environment. FIG. 5B is a block diagram of a deployment environment according to some example implementations. A system 540 includes hardware (e.g., a set of one or more server devices) and software to provide service(s) 542, including relevance prediction-based searching mechanism 110. In some implementations the system 540 is in one or more datacenter(s). These datacenter(s) may be: 1) first party datacenter(s), which are datacenter(s) owned and/or operated by the same entity that provides and/or operates some or all of the software that provides the service(s) 542; and/or 2) third-party datacenter(s), which are datacenter(s) owned and/or operated by one or more different entities than the entity that provides the service(s) 542 (e.g., the different entities may host some or all of the software provided and/or operated by the entity that provides the service(s) 542). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 540 is coupled to user devices 580A-580S over a network 582. The service(s) 542 may be on-demand services that are made available to one or more of the users 584A-584S working for one or more entities other than the entity which owns and/or operates the on-demand services (those users sometimes referred to as outside users) so that those entities need not be concerned with building and/or maintaining a system, but instead may make use of the service(s) 542 when needed (e.g., when needed by the users 584A-584S). The service(s) 542 may communicate with each other and/or with one or more of the user devices 580A-580S via one or more APIs (e.g., a REST API). In some implementations, the user devices 580A-580S are operated by users 584A-584S, and each may be operated as a client device and/or a server device. In some implementations, one or more of the user devices 580A-580S are separate ones of the electronic device 500 or include one or more features of the electronic device 500. In some embodiments, service(s) 542 includes relevance prediction-based searching mechanism 110.

In some implementations, the system 540 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 540 is a multi-tenant cloud computing architecture supporting multiple services, such as one or more of the following types of services: relevance prediction-based searching, document ranking and presentation, Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM).

For example, system 540 may include an application platform 544 that enables PAAS for creating, managing, and executing one or more applications developed by the provider of the application platform 544, users accessing the system 540 via one or more of user devices 580A-580S, or third-party application developers accessing the system 540 via one or more of user devices 580A-580S.

In some implementations, one or more of the service(s) 542 may use one or more multi-tenant databases 546, as well as system data storage 550 for system data 552 accessible to system 540. In certain implementations, the system 540 includes a set of one or more servers that are running on server electronic devices and that are configured to handle requests for any authorized user associated with any tenant (there is no server affinity for a user and/or tenant to a specific server). The user devices 580A-580S communicate with the server(s) of system 540 to request and update tenant-level data and system-level data hosted by system 540, and in response the system 540 (e.g., one or more servers in system 540) automatically may generate one or more Structured Query Language (SQL) statements (e.g., one or more SQL queries) that are designed to access the desired information from the multi-tenant database(s) 546 and/or system data storage 550.

In some implementations, the service(s) 542 are implemented using virtual applications dynamically created at run time responsive to queries from the user devices 580A-580S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 560 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 544 includes an application setup mechanism that supports application developers' creation and management of applications, which may be saved as metadata by save routines. Invocations to such applications, including relevance prediction-based searching mechanism 110, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 582 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols and may include one or more intermediary devices for routing data between the system 540 and the user devices 580A-580S.

Each user device 580A-580S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 540. For example, the user interface device can be used to access data and applications hosted by system 540, and to perform searches on stored data, and otherwise allow one or more of users 584A-584S to interact with various GUI pages that may be presented to the one or more of users 584A-584S. User devices 580A-580S might communicate with system 540 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 580A-580S might include an HTTP client, commonly referred to as a “browser,” for sending and receiving HTTP messages to and from server(s) of system 540, thus allowing users 584A-584S of the user devices 580A-580S to access, process and view information, pages and applications available to it from system 540 over network 582.

Conclusion. In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

In the detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B, or C” is intended to include the possibilities of “A,” “B,” “C,” “A and B,” “B and C,” “A and C,” and “A, B, and C.”

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

In addition, the articles “a” and “an” as used herein and in the appended claims should generally be construed to mean “one or more” unless specified otherwise or clear from context to be directed to a singular form. Reference throughout this specification to “an implementation,” “one implementation,” “some implementations,” or “certain implementations” indicates that a particular feature, structure, or characteristic described in connection with the implementation is included in at least one implementation. Thus, the appearances of the phrase “an implementation,” “one implementation,” “some implementations,” or “certain implementations” in various locations throughout this specification are not necessarily all referring to the same implementation.

Some portions of the detailed description may be presented in terms of algorithms and symbolic representations of operations on data bits within a computer memory. These algorithmic descriptions and representations are the manner used by those skilled in the data processing arts to most effectively convey the substance of their work to others skilled in the art. An algorithm is herein, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, or otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving,” “retrieving,” “transmitting,” “computing,” “generating,” “adding,” “subtracting,” “multiplying,” “dividing,” “optimizing,” “calibrating,” “detecting,” “performing,” “analyzing,” “determining,” “enabling,” “identifying,” “modifying,” “transforming,” “applying,” “aggregating,” “extracting,” “registering,” “querying,” “populating,” “hydrating,” “updating,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission, or display devices.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Any of the software components or functions described in this application can be implemented as software code to be executed by one or more processors using any suitable computer language such as, for example, C, C++, Java™, or Python using, for example, existing or object-oriented techniques. The software code can be stored as non- transitory instructions on any type of tangible computer-readable storage medium (referred to herein as a “non-transitory computer-readable storage medium”). Examples of suitable media include random access memory (RAM), read-only memory (ROM), magnetic media such as a hard-drive or a floppy disk, or an optical medium such as a compact disc (CD) or digital versatile disc (DVD), flash memory, and the like, or any combination of such storage or transmission devices. Computer-readable media encoded with the software/program code may be packaged with a compatible device or provided separately from other devices (for example, via Internet download). Any such computer-readable medium may reside on or within a single computing device or an entire computer system and may be among other computer-readable media within a system or network. A computer system, or other computing device, may include a monitor, printer, or other suitable display for providing any of the results mentioned herein to a user.

In the foregoing description, numerous details are set forth. It will be apparent, however, to one of ordinary skill in the art having the benefit of this disclosure, that the present disclosure may be practiced without these specific details. While specific implementations have been described herein, it should be understood that they have been presented by way of example only, and not limitation. The breadth and scope of the present application should not be limited by any of the implementations described herein but should be defined only in accordance with the following and later-submitted claims and their equivalents. Indeed, other various implementations of and modifications to the present disclosure, in addition to those described herein, will be apparent to those of ordinary skill in the art from the foregoing description and accompanying drawings. Thus, such other implementations and modifications are intended to fall within the scope of the present disclosure.

Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein, along with the full scope of equivalents to which such claims are entitled.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, U.S. Pat. No. 7,779,039, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art.

Therefore, the scope of the appended claims should be accorded the broadest interpretation so as to encompass all such modifications and similar arrangements. It is to be understood that the above description is intended to be illustrative, and not restrictive.

What is claimed is:

1. A computer-implemented method comprising:
receiving a query;
predicting relevance of documents associated with the query based on content of the query and historical user expectations, wherein the relevance is predicted based on comparison of a first relevance prediction with a second relevance prediction;
ranking the documents based on the predicted relevance, wherein the documents are sorted based on the ranking; and
communicating, in response to the query, the ranked and sorted documents to a computing device over a communication network.

2. The method of claim 1, wherein the first relevance prediction refers to historically known relevance that is obtained based on a first sample associated with the historical user expectation, and wherein the second relevance prediction is calculated based on a second sample associated with the historical user expectations.

3. The method of claim 1, wherein the historical user expectations comprise pre-assigned relevance relating to the documents, wherein the pre-assigned relevance includes the historically known relevance determined based on past treatments of the documents by a user, via the computing device, wherein one or more of the documents are historically regarded as more relevant than other documents of the documents when received in response to the query.

4. The method of claim 1, wherein the query and the documents correspond to an optimal ranking further corresponding to the first relevance prediction, wherein the documents and the optimal ranking are received to trigger a full permutation for the documents, wherein the first sample and the second sample include a first independent and identically distributed (IID) sampling mask and a second IID sampling mask, wherein the first and second IID sampling masks are applied to the full permutation to obtain the first and second samples, respectively.

5. The method of claim 1, further comprising applying a permutation invariant groupwise scoring function (PI-GSF) to the first and second samples to generate the first and second relevance predictions, respectively.

6. The method of claim 1, further comprising comparing the first relevance prediction with the second relevance prediction to obtain a difference between the first and second relevance predictions, wherein the difference indicates one or more distance measures, wherein the predicted relevance is based on the one or more ranking losses associated with the optimal ranking, wherein the documents are ranked and sorted based on the predicted relevance.

7. A database system comprising:
a server computer hosting a processing system coupled to a database, the processing system to facilitate operations comprising:
receiving a query;
predicting relevance of documents associated with the query based on content of the query and historical user expectations, wherein the relevance is predicted based on comparison of a first relevance prediction with a second relevance prediction;
ranking the documents based on the predicted relevance, wherein the documents are sorted based on the ranking; and
communicating, in response to the query, the ranked and sorted documents to a client computer over a communication network.

8. The database system of claim 7, wherein the first relevance prediction refers to historically known relevance that is obtained based on a first sample associated with the historical user expectation, and wherein the second relevance prediction is calculated based on a second sample associated with the historical user expectations.

9. The database system of claim 7, wherein the historical user expectations comprise pre-assigned relevance relating to the documents, wherein the pre-assigned relevance includes the historically known relevance determined based on past treatments of the documents by a user, via the client computer, wherein one or more of the documents are historically regarded as more relevant than other documents of the documents when received in response to the query.

10. The database system of claim 7, wherein the query and the documents correspond to an optimal ranking further corresponding to the first relevance prediction, wherein the documents and the optimal ranking are received to trigger a full permutation for the documents, wherein the first sample and the second sample include a first independent and identically distributed (IID) sampling mask and a second IID sampling mask, wherein the first and second IID sampling masks are applied to the full permutation to obtain the first and second samples, respectively.

11. The database system of claim 7, wherein the operations further comprise applying a permutation invariant groupwise scoring function (PI-GSF) to the first and second samples to generate the first and second relevance predictions, respectively.

12. The database system of claim 7, wherein the operations further comprise comparing the first relevance prediction with the second relevance prediction to obtain a difference between the first and second relevance predictions, wherein the difference indicates one or more distance measures, wherein the predicted relevance is based on the one or more ranking losses associated with the optimal ranking, wherein the documents are ranked and sorted based on the predicted relevance.

13. A computer-readable medium comprising having stored thereon instructions which, when executed, cause a computing device to facilitate operations comprising:
receiving a query;
predicting relevance of documents associated with the query based on content of the query and historical user expectations, wherein the relevance is predicted based on comparison of a first relevance prediction with a second relevance prediction;
ranking the documents based on the predicted relevance, wherein the documents are sorted based on the ranking; and
communicating, in response to the query, the ranked and sorted documents to a client computer over a communication network.

14. The computer-readable medium of claim 13, wherein the first relevance prediction refers to historically known relevance that is obtained based on a first sample associated with the historical user expectation, and wherein the second relevance prediction is calculated based on a second sample associated with the historical user expectations.

15. The computer-readable medium of claim 13, wherein the historical user expectations comprise pre-assigned relevance relating to the documents, wherein the pre-assigned relevance includes the historically known relevance determined based on past treatments of the documents by a user, via the client computer, wherein one or more of the documents are historically regarded as more relevant than other documents of the documents when received in response to the query.

16. The computer-readable medium of claim 13, wherein the query and the documents correspond to an optimal ranking further corresponding to the first relevance prediction, wherein the documents and the optimal ranking are received to trigger a full permutation for the documents, wherein the first sample and the second sample include a first independent and identically distributed (IID) sampling mask and a second IID sampling mask, wherein the first and second IID sampling masks are applied to the full permutation to obtain the first and second samples, respectively.

17. The computer-readable medium of claim 13, wherein the operations further comprise applying a permutation invariant groupwise scoring function (PI-GSF) to the first and second samples to generate the first and second relevance predictions, respectively.

18. The computer-readable medium of claim 13, wherein the operations further comprise comparing the first relevance prediction with the second relevance prediction to obtain a difference between the first and second relevance predictions, wherein the difference indicates one or more distance measures, wherein the predicted relevance is based on the one or more ranking losses associated with the optimal ranking, wherein the documents are ranked and sorted based on the predicted relevance.
